(19) United States
(12) Patent Application Publication
(10) Pub. No.: US 2010/0088689 A1
(43) Pub. Date: Apr. 8, 2010

(54) BRANDING BINARY MODULES USING RESOURCE PATCHING

(75) Inventors: Yakir Levi, Tel Aviv (IL); Slava Guzenko, Melbourne (AU); Henit Ben Adi, Mevo-Dotan (IL); Idit Cohen, Halamish (IL); Vladimir Skabelin, Raanana (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,445

(22) Filed: Oct. 3, 2008

(51) Int. Cl. G06F 9/44

(52) U.S. Cl. 717/168

(57) ABSTRACT

A resource patching tool is configured to enable resources from an external source module to be added or replaced in a binary module after the module is built as an executable program. A developer may use the resource patching tool to place different resources into a generic binary module to easily and efficiently create different branding without having to rebuild the module. Thus, for example, a single instance of agent.exe can be built that does not have any resources so that different resources patched into it post-build using the resource patching tool to thereby create different binary module configurations with the desired branding.

### BACKGROUND

Binary modules such as EXE (executable), DLL (dynamic linked library) and OCX (object linking and embedding control extension) are commonly utilized to provide modularized functionality to a program or application that runs on a computing platform such as a PC (personal computer). Each binary module can be loaded into the main program at run time which can speed up load time since a module is typically loaded only when the functionality that it provides is needed.

In addition, updates are often easier to apply to each binary module without affecting other parts of the program. For example, a payroll and benefits program may need to deal with tax rates that change every year. When these changes are isolated into a binary module, the module can be updated without needing to build or install the whole program again. This feature thus saves development time and expense while simplifying deployment and installation of the program in the runtime environment.

Binary modules typically contain program code and resources of various kinds and languages such as strings, icons, bitmaps, dialog templates, and menus. Binary modules may use the same code but be compiled with different sets of resources in order to create modules that have different configurations. For example, a binary module that implements an agent named agent.exe can have different resources to implement different branding for the module. Then during runtime, the user will interact with interface elements such as splash screens, icons, strings, menus, etc., that are specific to the module's branding. Use of different resources thus enables the user experience to be customized to a given application without needing to change the program code. However, existing methods for creating the different variations or “flavors” of binary modules require distinct configurations of the module to be compiled with each having the same code but using different resources. These methods are inefficient by requiring developers to expend more time and effort to create the desired binary modules.

### SUMMARY

A resource patching tool is configured to enable resources from an external source module to be added or replaced in a binary module after the module is built as an executable program. A developer may use the resource patching tool to place different resources into a generic binary module to easily and efficiently create different branding without having to rebuild the module. Thus, for example, a single instance of agent.exe can be built that does not have any resources so that different resources cab be patched into it post-build using the resource patching tool to create different binary module configurations with the desired branding.

In various illustrative examples, the resource patching tool is implemented to be run using a command line interface on a computing platform such as a PC. Using command lines, a developer can add or replace resources from a source module into the destination binary module where the resource types may include icon, menu, string, and binary. Version resources (e.g., a file version or product version) can be replaced and also edited. Multi-language support is enabled so that, for example, an English language string can be replaced by a Japanese language string. And, resources can be patched into multiple destination binary modules simultaneously.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows typical application development and usage environments in which a binary module is built to implement various interface elements when executing during runtime;

FIG. 2 shows an illustrative group of differently configured binary modules and associated resources that are typically utilized to provide programs with user experiences that have different branding;

FIG. 3 shows an illustrative generic binary module into which resources can be patched post-build using the resource patching tool;

FIG. 4 shows various illustrative capabilities of the resource patching tool; and

FIG. 5 shows additional operative details of the resource patching tool which include the generation of a log.

Like reference numerals indicate like elements in the drawings.

### DETAILED DESCRIPTION

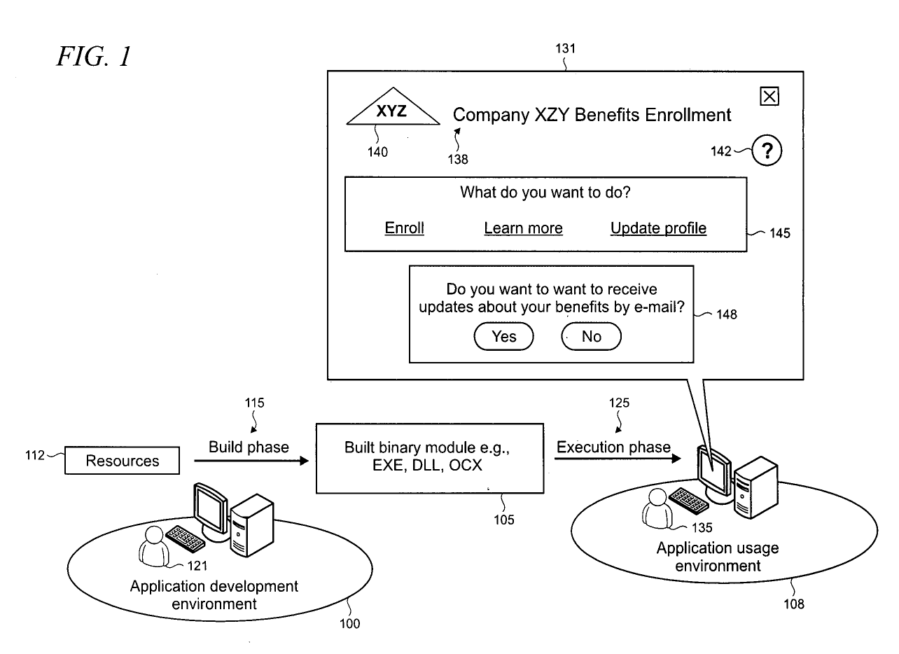

FIG. 1 shows a typical application development environment 100 that is used to build a binary module 105 that executes in a usage environment 108. The binary module 105, in this illustrative example, uses resources 112 that are included during a build phase of the module (as indicated by reference numeral 115) in the development environment 100. That is, a developer 121 will typically specify resources that get compiled with code into the binary module 105 to produce a desired programmed behavior during the module's execution phase (as indicated by reference numeral 125 in the usage environment 108. The binary module 105 can vary by type, but will often typically comprise an EXE, DLL, OCX, or other executable.

The particular resources 112 used can vary by implementation, but in this example include interface elements of various kinds such as strings, icons, bitmaps, dialog templates, and menus. The resources may also be constructed using different languages (e.g., English, French, Hebrew, Japanese, etc.). As shown in FIG. 1, the interface elements comprising the resources 112 can be used to implement a user experience such as graphical user interface (“GUI”) 131 that uses branding. The branding is implemented for a user 135 in the application usage environment 108 through the various interface elements that are created and displayed in the GUI 131 during the execution phase 125 of the binary module 105. These elements include strings 138, bitmaps 140, icons 142, menus 145, and dialog boxes 148. It is emphasized that the particular interface elements shown in this example are intended to be illustrative only and that other interface elements may be used in various combinations as may be required in a given implementation.

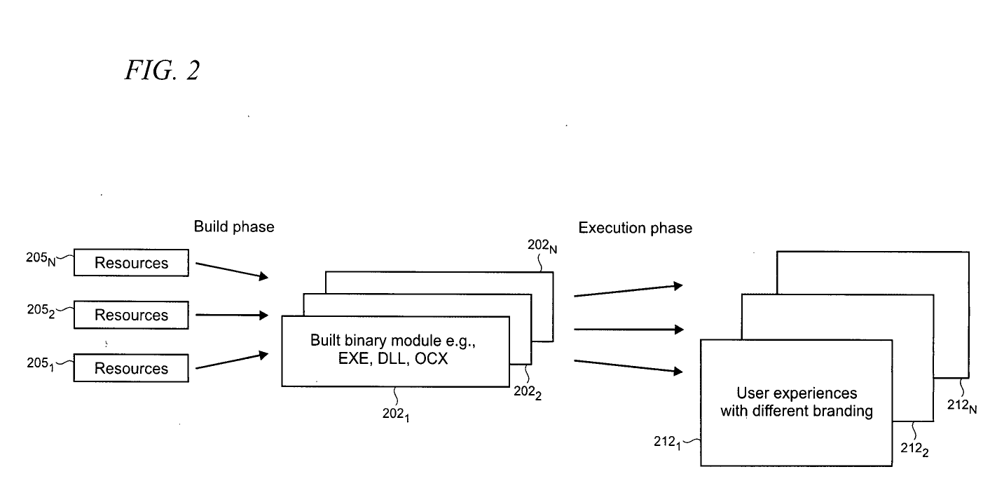

As shown in FIG. 2, in typical existing development environments, the developer will generally need to build multiple different binary modules 202_{1,2 . . .} N in order to implement different branding configurations (i.e., “flavors”) for the user experience which may use different interface elements. Each binary module configuration will use different respective resources 205_{1,2 . . . N} but will typically use the same program code. In this way, each GUI 212_{1, 2 . . . N} can have a different look and feel, use different languages, etc., when a binary module runs during the execution phase. However, providing the different configurations has a cost in development time and effort to build the multiple binary modules 202 and can thus be inefficient.

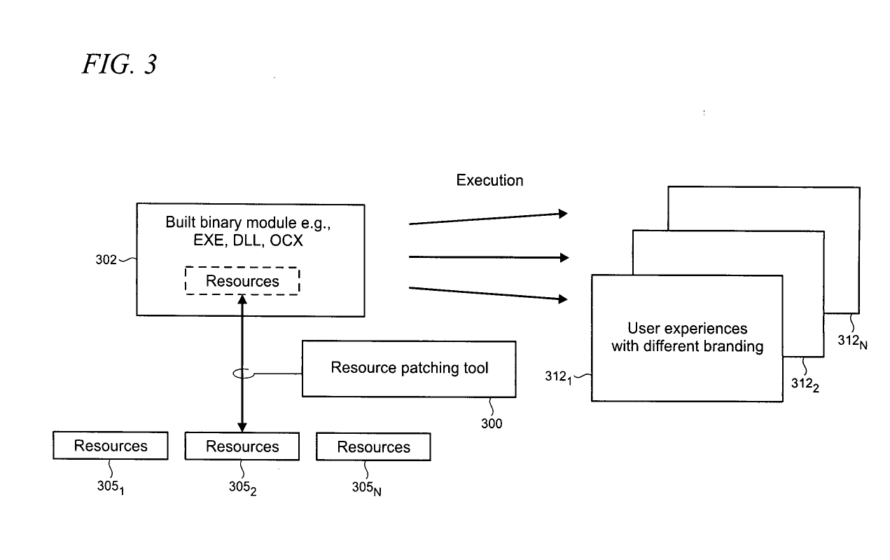

In comparison to current methods, the present resource patching tool enables a more streamlined and efficient process for creating multiple flavors of a binary module that can provide, for example, user experiences having different branding. As shown in FIG. 3, the resource patching tool 300 enables resources to be added or replaced into an existing binary module 302 post-build. In other words, the binary module can go through its normal development cycle but be compiled without any resources (or be compiled with resources that get replaced, or edited in some cases). Then, after it is built, the developer can go in and use the resource patching tool 300 to modify the binary module 302 with different sets of resources 305_{1, 2 . . . N} to implement the desired branding, such as GUIs 312_{1,2 . . . N,} as shown, during execution. Use of the resource patching tool 300 therefore enables a single generic binary module to be built once and then have its multiple favors efficiently and quickly implemented by adding or replacing the appropriate resources 305.

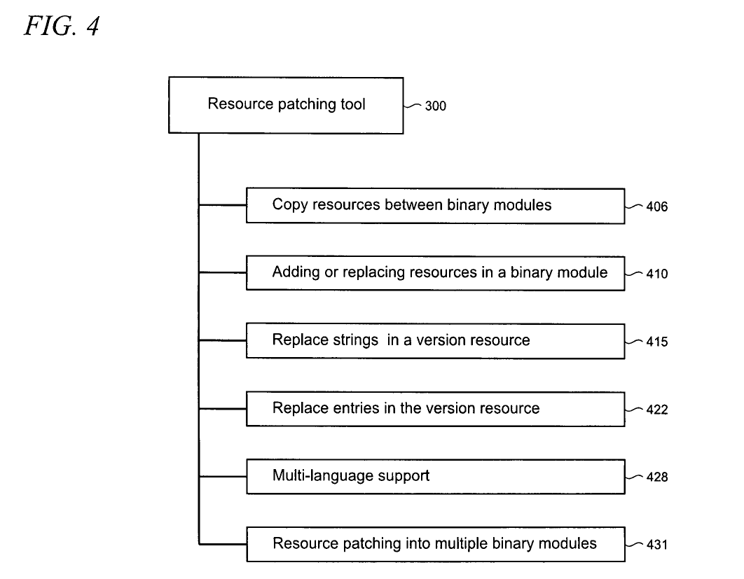

More specifically, as shown in FIG. 4, the resource patching tool 300 may be arranged to support a variety of features and functionalities. These include, for example, copying resources between binary modules (as indicated by reference numeral 406), adding or replacing resources in a binary module (410), replacing strings in a version resource (e.g., a file version or a program version) (415) such as changing “ABC Tech Co” to “ABC Technologies”, replacing entries in a version resource (422) such as the name of the publishing company, providing support for multiple languages (428), and patching the same set of resources into multiple binary modules (431). However, it is emphasized that these features and functionalities are merely illustrative. Not all such features and functionalities shown in FIG. 4 need to be supported in every implementation, and other features and functionalities may also be supported by the resource patching tool if needed.

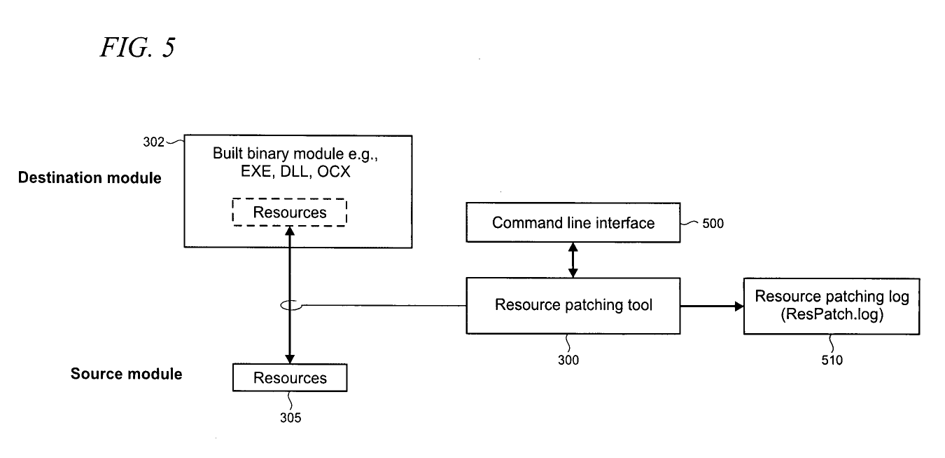

In one illustrative example, the resource patching tool 300 may be implemented using program code running on a computing platform such as a PC and that exposes a command line interface 500, as shown in FIG. 5. However, in other implementations, other types of user interfaces may also be employed such as GUIs and the like.

The command line interface 500 is configured to accept arguments as inputs in pairs—the first part of the pair specifying the role of the argument and the second part providing the argument's value. In some cases the value of the argument is a dummy value which means the content of the value is ignored even though its existence may be compulsory.

For purposes of the explanation of the command line arguments that follows, as shown in FIG. 5, the binary module 302 is referred to as the “destination module” and the resource file is referred to as the “source module.” The following illustrative command line arguments may be utilized by the present resource patching tool:
B—Save a backup for the destination module. By default there is no backup. (dummy value)
C—Codepage of the string in the version resource. A list of supported codepages is available at http//msdn.com if “Character Set Recognition” is input as a search. If the codepage has the letter A (e.g. 932A or 932a), the strings will be converted from ANSI character set an OEM character set (i.e., from Windows code page to DOS code page).
E—The source is an external file (supported resource types may include binary, manifest, and string).
   B—Binary or manifest support.
   S—String in the command line.
   I—String from an ini file. String size is limited to 1024 characters. The string is the data value of an ini key.
   Note: E can be a standalone parameter in which case it is used with a dummy value. (/e “dummy”).
S—Path to the key which data value is a String. Used combined with /ei.
F—Force operation on a folder tree without confirmation (see R below). (dummy value)
I or ID—Resource ID in the destination module. It can be an existing one, in which case the existing resource will be replaced, or a new one, so the new resource will be added.
IS—Resource ID in the source module.
K—Key in the version resource.
   If the key starts with “fixed:” (case insensitive) then it is a member of the fixed info structure. In that case the strings must contain numbers, decimal or hexadecimal (0x . . . ).
   After the word “fixed:” should be one of the VS_FIXEDFILEINFO member value names (e.g. fixed:dwFileVersionLS).
   Otherwise the key is one of the values displayed in the version info as an executable.
L—Language ID of the resource. Values should be numbers representing LANGIDs as appears at http://msdn.com
M or MD—Path to the destination module. If it only contains a name then the system searches in folders as specified in the documentation of LoadLibrary.
MS—Path to the source module. The comment pertaining to MD applies.
N—New String in the version resource, the one that should be inserted into the destination module.
O—Old String in the version resource, the one that should be deleted from in the destination module.
R—Root folder when resource patching should apply to the contents of a folder tree.
   In this case the destination module should be a masked file name (e.g. *.dll or ?Agent.exe).
   Note: If there is no root folder and the destination module is a mask the folder where ResPatch resides is the root folder.
   Unless /f is specified a message box confirming the operation.
T—Resource Type*. Can be a numbers or strings according to the documentation of the function FindResource.
V—Version and then the 4 integers (<65536) separated by dots representing the new version: #.#.#.#.
Will replace File Version and Product Version.
VF—Like V, for replacing File Version only.
VP—Like V, for replacing Product Version only.
FC—Final Check: tries to load the patched resource and verifies it was patched correctly. Also pops up a message box on failure.
note that Resource Types may be located at http://msdn2.microsoft.com/en-us/library/ms648009.aspx

| Value | Num |
|---|---|
| RT_ACCELERATOR | 9 |
| RT_ANICURSOR | 21 |
| RT_ANIICON | 22 |
| RT_BITMAP | 2 |
| RT_CURSOR | 1 |
| RT_DIALOG | 5 |
| RT_DLGINCLUDE | 17 |
| RT_FONT | 8 |
| RT_FONTDIR | 7 |
| RT_GROUP_CURSOR | 12 |
| RT_HTML | 23 |
| RT_ICON | 3 |
| RT_MANIFEST | 24 |
| RT_MENU | 4 |
| RT_MESSAGETABLE | 11 |
| RT_PLUGPLAY | 19 |
| RT_RCDATA | 10 |
| RT_STRING | 6 |
| RT_VERSION | 16 |
| RT_VXD | 20 |

When editing version resources, the following arguments are relevant:
Destination Module (md), New String (n), Old String (o), Key (k), Language (l), Codepage (c), Backup (b).
For replacing strings within the version resource regardless of key. The replaced string can be a substring of a key (e.g. replacing GTAgent with PCPal where the resource is GTAgent Browser will output PCPal Browser.
The following arguments are mandatory:
   Destination module (md).
   New string (n).
   Old string (o).
For editing entries within the version resource the following arguments are mandatory:
   Destination module (md).
   New string (n).
   Key (k).
Optional:
   Backup (b).
   Language (l). Use it if the version resource is not English.
   Codepage (c). Use it if the strings within the English version resource are not English.

For replacing resources the following arguments are relevant:
Mandatory:
   Destination module (md). Copying into it.
   Source module (md). Copying from it.
   Resource type (t).
   Resource ID in the destination module (id).
   Resource ID in the source module (is).
Optional
   Backup (b).
   Language (l). Use it if the resource is not English.

Also shown in FIG. 5 is a resource patching log 510 (named ResPatch.log) that is created by the resource patching tool 300. The resource patching log is used to indicate whether resource patching is successful. The ResPatch.log file will typically be located in a temporary directory.

Several illustrative examples of input to the command line interface 500 now follow. Note that argument values that contain spaces are framed with quotation marks. In addition, argument roles should have ‘−’ or ‘/’ as their first character.
Replacing/adding an icon.
   We copy icon 165 from AURsrc.dll as 200 in AuAgent.exe.
   Note the quotation marks.
      respatch /md s:\AuAgent.exe /ms “s:\My Folder\AURsrc.dll” /t 14 /id 201 /is 165
Replacing/adding a Japanese menu and saving backup of the original file:
   respatch /md AUBrowse.exe /ms “AURsrc.dll” /t 4 /id 200 /is 163 /l 1041 /b
   respatch /md AUBrowse.exe /ms “AURsrc.dll” /b “dummy” /t 4 /id 200 /is 163 /l 1041
Replacing an English string with a Japanese one in an English version resource in a folder tree (without confirmation):
   respatch /f “true” /r s:\test /md *.exe /o GTAgent /n “Canon POP [symbol] -” /c 932
Replacing a version of a file (both product version and file version).
   This is potentially tricky because there are 4 fixed values that contain the versions and 2 strings so we might need 6 calls.
   Here we change the file and product version of qdiagd.ocx from 1.0.1.424 to 1.0.1.422.
   Note: we need to change 2 fixed values because the high version numbers are left “1.0”.
   respatch /m qdiagd.ocx /k fixed:FileVersionLS /o 0x101a8 /n 0x101a6
   respatch /m qdiagd.ocx /k FileVersion /o “1, 0, 1, 424” /n “1, 0, 1, 422”
   respatch /m qdiagd.ocx /k fixed:ProductVersionLS /o 0x101a8 /n 0x101a6
   respatch /m qdiagd.ocx /k ProductVersion /o “1, 0, 1, 424” /n “1, 0, 1, 422
Adding a String from an external resource.
   respatch /md s:\GTAAgnt.exe /es “Canon POP” /id 555
   respatch /md s:\GTAAgnt.exe /ei “C:\res.ini” /s section1\Key1 /id 544
   respatch /md s:\GTAAgnt.exe /eb noelevation.manifest /t “RT_MANIFEST” /id 1
   respatch /md s:\GTAAgnt.exe /ms noelevation.manifest /e “false” /t “RT_MANIFEST” /id 1
   respatch /md s:\GTAAgnt.exe /ms noelevation.manifest /t “RT_MANIFEST” /id 1 /e
Adding a user defined passing the resource as a string.
   respatch /md s:\GTAAgnt.exe /t USERT /es “00 04 00 56 22 00” /id 501
Replacing version (all, file only, product only):
   respatch /md s:\GTAAgnt.exe /v “1.0.0.53”
   respatch /md s:\GTAAgnt.exe /vf “1.1.0.53”
   respatch /md s:\GTAAgnt.exe /vp “1.2.0.53”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, perform a method for patching resources into a binary module, the method comprising the steps of:
providing a user interface for enable selection of a destination binary module into which a resource from a source module may be patched; and
patching the selected resource into the binary module post-build to generate a binary module having branding that is implemented according to the patched resource.

2. The computer-readable medium of claim 1 in which the resource patching comprises one of copying a resource from an executable to the binary module, adding a resource to the binary module, replacing a resource in the binary module, or editing a resource in the binary module.

3. The computer-readable medium of claim 2 in which the editing comprises editing version information.

4. The computer-readable medium of claim 2 in which the resource comprises one or more interface elements, the interface elements being selected from at least one of strings, icons, bitmaps, dialog templates, or menus.

5. The computer-readable medium of claim 4 in which different resources are configured for supporting different languages.

6. The computer-readable medium of claim 1 including a further step of generating a resource patching log file for indicating if the patching is successful.

7. The computer-readable medium of claim 1 in which the binary module is an executable file.

8. The computer-readable medium of claim 7 in which the binary module is one of EXE, DLL, or OCX.

9. A method for generating a binary module, the method comprising the steps of:
compiling a generic binary module;
patching a first set of resources into the compiled generic binary module on a post-build basis; and
repeating the patching with a second set of resources to generate different configurations of the generic binary module, the configurations when executed at run time each implementing a user experience having different branding.

10. The method of claim 9 in which the patching is performed using a resource patching tool.

11. The method of claim 10 in which the resource patching tool implements a command line interface for selecting a source module from which a resource is copied and a destination binary module into which the resource is patched.

12. The method of claim 11 in which the command line interface processes arguments in pairs, a first element in a pair specifying a role of the argument and a second element in the pair specifying a value.

13. The method of claim 12 in which the value is a dummy value.

14. The method of claim 9 in which the first and second set of resources comprise interface elements.

15. The method of claim 9 in which the different branding varies by one of icon, menu, dialog box, bitmap, or string.

16. A computer-readable medium containing instructions which, when executed by one or more processors disposed in an electronic device, implement a binary module that is arranged for performing a method comprising the steps of:
implementing a functionality that utilizes branding, the branding being realized through interface elements that are implemented using a set of resources that is incorporated into the binary module; and
accepting changes to the set of resources after the binary module is built but before the binary module is executed in a runtime environment so that the binary module may be customized to a given application.

17. The computer-readable medium of claim 16 in which the accepting comprises one of adding, replacing, or modify the set of resources.

18. The computer-readable medium of claim 16 in which the functionality is implemented using program code, the program code being unaffected by changes to the set of resources.

19. The computer-readable medium of claim 16 in which the changes to the set of resources are made using a resource patching tool.

20. The computer-readable medium of claim 16 in which the interface elements are selected from at least one of bitmap, icon, string, dialog box template, or menu.
